(19) United States
(12) Patent Application Publication
(10) Pub. No.: US 2009/0113305 A1
(43) Pub. Date: Apr. 30, 2009

(54) Method and system for creating audio tours for an exhibition space

(76) Inventors: Elizabeth Sherman Graif, Scarsdale, NY (US); Robert Klerer, Scarsdale, NY (US)

Correspondence Address: Michael R. Graif, 7 Kempster Road, Scarsdale, NY, 10583, US

(21) Appl. No.: 12/051,843

(22) Filed: Mar. 19, 2008

Related U.S. Application Data
(60) Provisional application No. 60/895,730, filed on Mar. 19, 2007.

(51) Int. Cl. G06F 3/048

(52) U.S. Cl. 715/727

(57) ABSTRACT

The present invention describes a system and method for planning and authoring an audio and/or video guided tour of an exhibition space, such as a museum or gallery. A mapmaking tool is provided whereby the user can graphically map the exhibition space and the location of the exhibits within that space. An authoring tool is also provided whereby the user can, with the resulting map of an exhibition space resulting from the mapmaking tool, record audio tours for each exhibit. If the location of an exhibit is changed, the associated audio and/or video tour remains associated with such exhibit.

This application claims priority from U.S. provisional application No. 60/895/730, filed Mar. 19, 2007.

### FIELD OF THE INVENTION

This invention relates to a method and system for creating audio and visual tours tailored to an exhibition space.

### SUMMARY OF THE INVENTION

The present invention is directed to a system that enables the independent planning and authoring of a guided audio and/or video tour of an exhibition space.

Exhibition spaces, such as museums and galleries, frequently change both their inventory on display, and the layout of the exhibition space. Current systems for creating audio tours are not versatile enough to easily enable revision of the audio tour when exhibition space and inventory change. Further, current systems do not permit the creation of audio tours of exhibition spaces by independent tour authors.

The present invention provides an independent tour author with the tools to create an audio and video tour of an exhibition space. A mapmaking tool is provided whereby a user can create a visual layout of the exhibition space and the objects on display. The tool enables the user to design an exhibition space, or to mimic an existing exhibition space. The user can lay out various exhibition rooms, together with the location of objects within a room. The mapmaking tool stores the data for easy access and retrieval, such that if an exhibition room or the exhibits within a room change, the tool enables easy revision to reflect the changes.

After creating a map of the exhibition space, an authoring tool is provided whereby the user can record audio segments and match them to specific objects in the exhibition space show in and resulting from the mapmaking tool. The authoring tool permits the audio segments to be re-arranged and to move with an object that, for example, is moved using the mapmaking tool into a different room. The resulting audio and/or video tour then instantly reflects the changed space.

### BRIEF DESCRIPTION OF THE DRAWINGS

FIG. 1 depicts a flow chart for an exemplary embodiment of the mapmaking tool of the invention;

FIG. 2 depicts a flow chart for an exemplary embodiment of the authoring tool of the invention.

### DETAILED DESCRIPTION

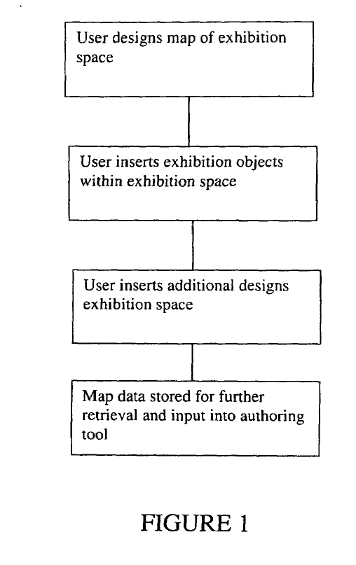

In an embodiment of the present invention as shown in FIG. 1, the system includes a mapmaking tool that permits an author to design an exhibition space on a computer. Once the exhibition space is created, the user can then insert objects that form part of the exhibition into the various rooms, and can move those exhibits around within the mapmaking tool as needed. The tool enables a user to choose various shapes of rooms, and includes passageways, hallways, and icons for bathrooms, elevators, stairs, cafes, exits and coat check. In a handheld tour device that permits video display, the icons can be displayed as part of an audiovisual guided tour of an exhibition space. In another embodiment of the present invention, the handheld tour device senses where it is located in the exhibition space by a variety of means, including RFID or GPS, for example, and displays a map of the area in which the exhibition viewer is located with the device. This permits the exhibition viewer to find his or her location, and locations of bathrooms and exits, for example, as well as exhibit objects within the exhibition space.

A user may design an exhibition space, room by room, designating not only the locations of exhibition objects, but also hallways, stairways, and attractions. Once the space has been mapped, each exhibit object can be separately named, and moved to accommodate the changing needs of the exhibition. All of the mapmaking data is then stored for the purpose of further retrieval, revisions, and input into audio tour authoring.

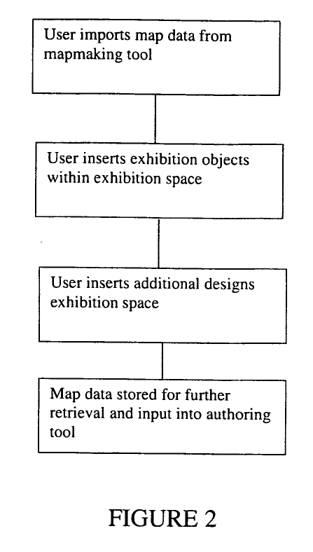

The data and detailed map resulting from use of the mapmaking tool can then be input into the authoring tool, as shown in FIG. 2. The authoring tool permits a user to record audio segments corresponding to various exhibits within the exhibition space, which have been input using the mapmaking tool. If the exhibit moves within the exhibition space, the corresponding audio segment will remain matched to the exhibit, permitting a user to re-arrange the exhibition space and maintain the audio tour using the mapmaking tool combined with the authoring tool.

In another embodiment of the present invention, the authoring tool permits more than one audio segment to be recorded for a given exhibit, so that a handheld device could offer different tour experiences for the same exhibition, such as a child-oriented tour, or a tour in another language, for example.

A viewer of the exhibition can pre-select his or her preferred themed tour, which can be downloaded onto a handheld device from a designated kiosk. In one embodiment of the invention, the handheld device would locate itself within the exhibition space and automatically prompt the user in the vicinity of an exhibition object for which an audio segment has been pre-recorded. In still another embodiment, there would be a visual display on the handheld device showing a portion of the map where the user is located within the exhibition space, permitting the user to find the closest exit, bathroom or cafe, for example.

We claim:

1. A method for creating themed audio tours of an exhibition space, comprising:
a) rendering a map of said exhibition space;
b) inserting the locations of objects to be displayed in the exhibition on said map;
c) recording of one or more audio segments having different themes that are matched to each of said objects;
d) generating one or more audio tours for said exhibition space corresponding to each of said themes.

2. The method of claim 1, further comprising providing a mapmaking tool to render said map, and providing an authoring tool to record said audio segments.

3. The method of claim 1, further comprising inserting visual icons on said map showing the locations of various attractions and facilities within said exhibition space.

4. A system for creating themed audio tours of an exhibition space, comprising:
a) a mapmaking tool that enables the creation of a map for an exhibition space, and the insertion of icons designating exhibition objects in the map
b) an authoring tool that uses permits recording of one or more themed audio segments for each of said exhibition objects, and the linking of the audio segments to said exhibition objects on said map.
c) creating themed audio tours for all of said exhibition objects using said audio segments.
